(19) United States
(12) Patent Application Publication
(10) Pub. No.: US 2024/0247970 A1
(43) Pub. Date: Jul. 25, 2024

(54) WEIGHT DETECTION SYSTEM FOR A LIFTING DEVICE

(71) Applicant: MILWAUKEE ELECTRIC TOOL CORPORATION, Brookfield, WI (US)

(72) Inventors: Beau A. Harrier, Brown Deer, WI (US); Caleb R. Hendryx, Waukesha, WI (US); Allison M. Neuser, Wauwatosa, WI (US); Garrett P. Mitchell, Milwaukee, WI (US); Evan M. Glanzer, Milwaukee, WI (US); Joseph W. Miller, Waukesha, WI (US); Will Didier, Cedarburg, WI (US)

(21) Appl. No.: 18/421,449

(22) Filed: Jan. 24, 2024

Related U.S. Application Data
(60) Provisional application No. 63/521,791, filed on Jun. 19, 2023.
(60) Provisional application No. 63/467,186, filed on May 17, 2023.
(60) Provisional application No. 63/481,249, filed on Jan. 24, 2023.

(51) Int. Cl. G01G 19/08; B66F 9/075; B66F 9/24

(52) U.S. Cl. CPC G01G 19/083; B66F 9/0759; B66F 9/24

(57) ABSTRACT

A lifting device includes a base, a mast coupled to the base, a carriage coupled to the mast, and a lifting assembly configured to move the mast and carriage in a first direction to a desired elevation relative to the base. The lifting device includes an electric motor, a battery pack for providing electrical power to the electric motor and a spool with a cable to alternately raise and lower the carriage in the first direction. The lifting device includes means for detecting a weight and/or a center of gravity of a load to be lifted by the lifting device, and a user interface operable to communicate information about the weight and/or the center of gravity of the load to a user of the lifting device.

### CROSS-REFERENCE TO RELATED APPLICATIONS

This application claims priority to U.S. Provisional Patent Application No. 63/521,791, filed on Jun. 19, 2023, U.S. Provisional Patent Application No. 63/467,186, filed on May 17, 2023, and U.S. Provisional Patent Application No. 63/481,249, filed on Jan. 24, 2023, the entire contents of all of which are incorporated herein by reference.

### FIELD OF THE INVENTION

The present invention generally relates to weight detection systems, and more particularly to weight detection systems for lifting devices.

### BACKGROUND OF THE INVENTION

Lifting devices are used to lift loads from the ground and install the load at a desired height and location. A weight of the load and a center of the load are characteristics that are considered in the operation of the lifting device. However, conventional lifting devices do not properly measure or determine the weight of the load before performing the lifting operation. An improper load weight is undesirable during the lifting operation. A proper load weight is desirable to safely lift the load to the desired height and location.

### SUMMARY OF THE INVENTION

The present invention provides, in one aspect, a lifting device including a base, a mast coupled to the base, a carriage coupled to the mast, and a lifting assembly configured to move the mast and carriage in a first direction to a desired elevation relative to the base. The lifting device includes an electric motor, a battery pack for providing electrical power to the electric motor and a spool with a cable to alternately raise and lower the carriage in the first direction. The lifting device includes means for detecting a weight and/or a center of gravity of a load to be lifted by the lifting device, and a user interface operable to communicate information about the weight and/or the center of gravity of the load to a user of the lifting device.

The present invention provides, in another aspect, a lifting device including a base, a mast coupled to the base, a carriage coupled to the mast, and a lifting assembly configured to move the mast and carriage in a first direction to a desired elevation relative to the base. the lifting assembly includes an electric motor, a battery pack for providing electrical power to the electric motor, and a spool with a cable to alternatively raise and lower the carriage in the first direction. The lifting device also includes means for detecting a tension in the cable in response to a load carried by the carriage, the detecting means configured to output a voltage signal proportional to a weight of the load.

The present invention provides, in another aspect, a lifting device including a base, a mast coupled to the base, a carriage coupled to the mast, and a lifting assembly configured to move the mast and carriage in a first direction to a desired elevation relative to the base. The lifting assembly includes an electric motor, a battery pack for providing electrical power to the electric motor, and a spool with a cable to alternately raise and lower the carriage in the first direction. The lifting device also includes a sensor apparatus configured to detect a tension in the cable in response to a load carried by the carriage. The sensor apparatus includes an idler pulley around which the cable is at least partially wrapped, a spring compressible from an initial state to a loaded state in response to a force applied to the idler pulley by the tension in the cable, one or more magnets configured to emit a magnetic field, and a sensor configured to detect the magnetic field emitted by the one or more magnets and output a voltage signal proportional to a weight of the load.

### BRIEF DESCRIPTION OF THE DRAWINGS

FIG. 1 illustrates a perspective view of a lifting device.

FIG. 2 illustrates a perspective view of a portion of the lifting device.

FIG. 3 illustrates a perspective view of a lifting assembly for the lifting device.

FIG. 4 illustrates a perspective view of a remote control unit for the lifting device according to an embodiment of the invention.

FIG. 5 illustrates the lifting device of FIG. 1 further including one or more sensors.

FIG. 6 illustrates a sensor configuration for use with the lifting device of FIG. 1.

FIG. 7 illustrates a sensor configuration according to an embodiment of the invention, for use with the lifting device of FIG. 1.

FIG. 8 illustrates a detailed view of the sensor configuration of FIG. 7.

FIG. 9 illustrates a sensor configuration according to an embodiment of the invention, for use with the lifting device of FIG. 1.

FIG. 10 illustrates a detailed view of the sensor configuration of FIG. 9.

FIG. 11 illustrates a sensor configuration according to an embodiment of the invention, for use with the lifting device of FIG. 1.

FIG. 12 illustrates a detailed view of the sensor configuration of FIG. 11.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

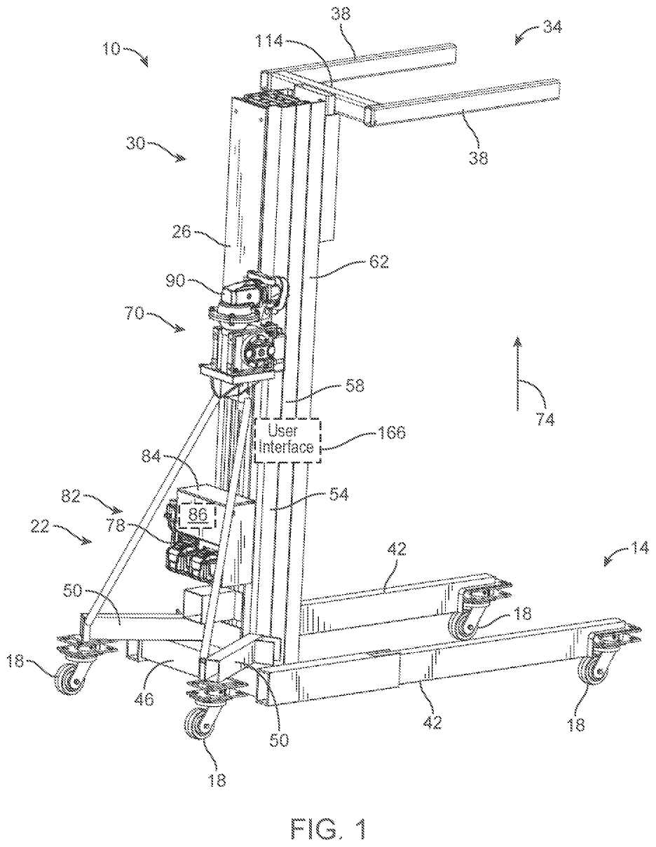

FIG. 1 illustrates a lifting device 10 that is able to rigidly (e.g., lift from below) lift materials (e.g., pipes, weights, loads, etc.) and move the material to a desired height and location (e.g., an installation height). The lifting device 10 includes a base 14 having a plurality of wheels 18, a support structure 22 having a first end coupled to the base 14 and a second end coupled to a back plate 26, a mast 30 extending from the base 14, and a carriage 34 coupled to the mast 30. The carriage 34 includes parallel first and second arms 38 that extend from the mast 30.

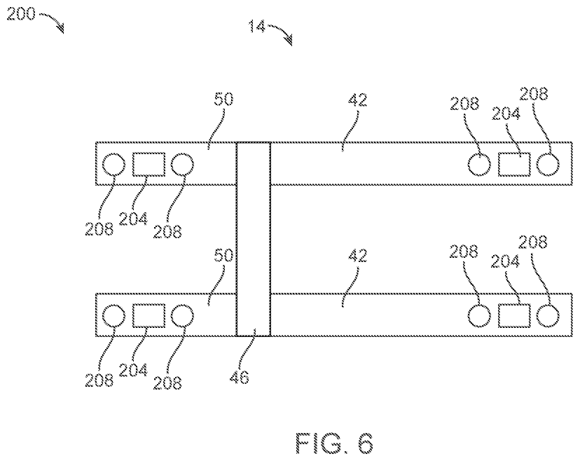

In the illustrated embodiment, the base 14 includes parallel first and second base rails 42 that extend from each end of a cross-beam 46, and an additional two frame rails 50 that obliquely extend from the cross-beam 46. In other embodiments, the two frame rails 50 are parallel to each other and extend from the cross-beam 46 (FIG. 6). The wheels 18 are coupled to a distal end of each of the rails 42, 50. As a result, wheels 18 are positioned in each corner of the base 14. In some embodiments, the first and second base rails 42 may pivot relative to the cross-beam 46 to facilitate movement and storage of the lifting device 10. In some embodiments still, the first and second base rails 42 may extend away (e.g., telescoping) from the cross-beam 46 to accommodate different material weights supported by the lifting device 10.

The mast 30 includes a first (stationary) mast portion 54 that is rigidly coupled to the backplate 26 and the cross-beam 46, and second and third (movable) mast portions 58, 62 that are coupled to and movable relative to the first mast portion 54. In other embodiments, more or fewer mast portions may be used. In the illustrated embodiment, each mast portion 54, 58, 62 of the mast 30 includes a telescoping structure that engages with a corresponding mast portion so the mast 30 and the carriage 34 are movable between a plurality of positions. For example, the telescoping structures may be a track formed on an outer surface of the mast portions 54, 58, 62. The track may receive a roller that allows movement of the mast portions 58, 62 relative to the first mast portion 54 and each other.

With reference back to FIG. 1, the lifting device 10 includes a lifting assembly 70 that is coupled to the mast 30 and is operable to move the mast 30 and the carriage 34 in a first (vertical) direction 74 to a desired elevation relative to the base 14. The lifting assembly 70 receives electrical power from one or more battery packs 78.

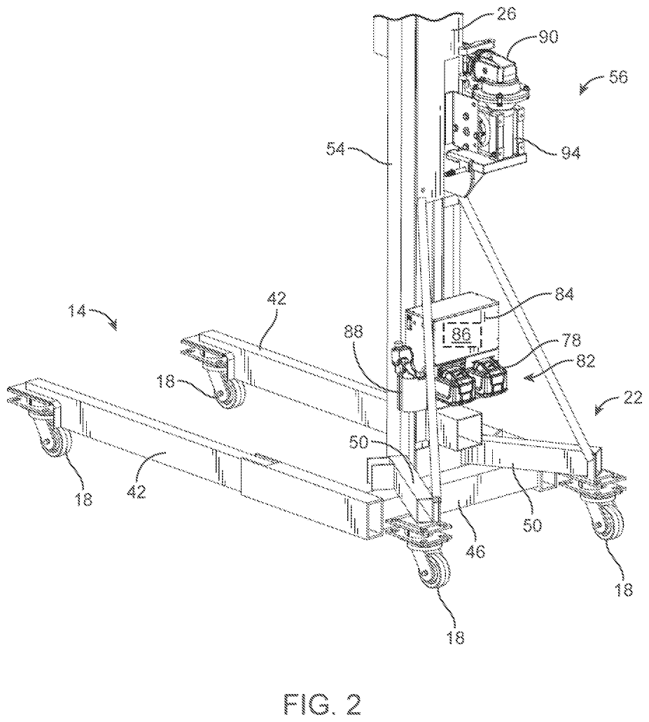

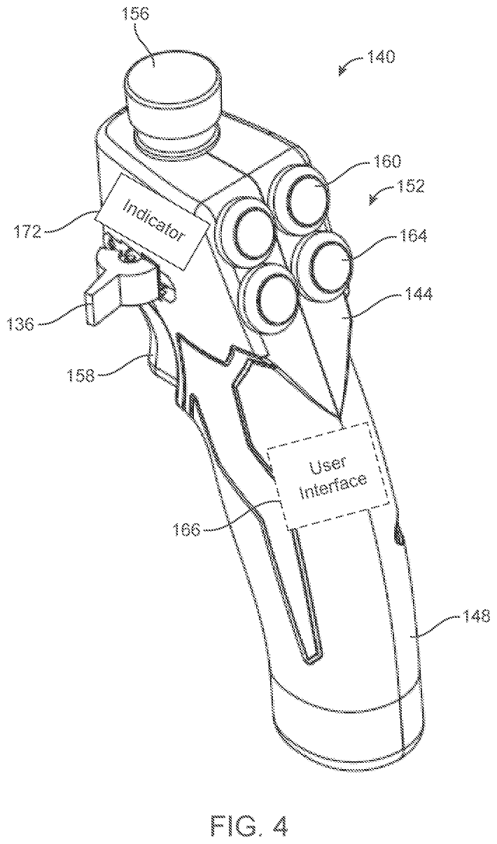

Now with reference to FIG. 2, the one or more battery packs 78 are secured within a battery receptacle 82 that is coupled to the first mast portion 54. An electronics housing 84 containing an electronic control unit 86 is further coupled to the mast 30 or the first mast portion 54. As described in more detail below, a remote control unit 140 (FIG. 4) can be detachable from the lifting device 10, and is either in wireless communication with the lifting device 10 or in wired communication with the lifting device 10. The remote control unit 140 (FIG. 4) can be in wireless communication with the lifting device 10 and operable (e.g., via a wireless connection with a transceiver or combination transmitter/receiver housed in the electronics housing 84) to control the movement of the mast 30 and the carriage 34. In other embodiments, the remote control unit 140 can be tethered to the lifting device 10 (e.g., via a wired connection with the electronics housing 84) to control the movement of the mast 30 and the carriage 34. The remote control unit 140 may be housed in a control housing 88 positioned adjacent the battery receptacle 82 (FIG. 2). For example, the control housing 88 is coupled to the battery receptacle 82 (e.g., via fasteners) to allow the operator to store the remote control unit 140 when it is not in use.

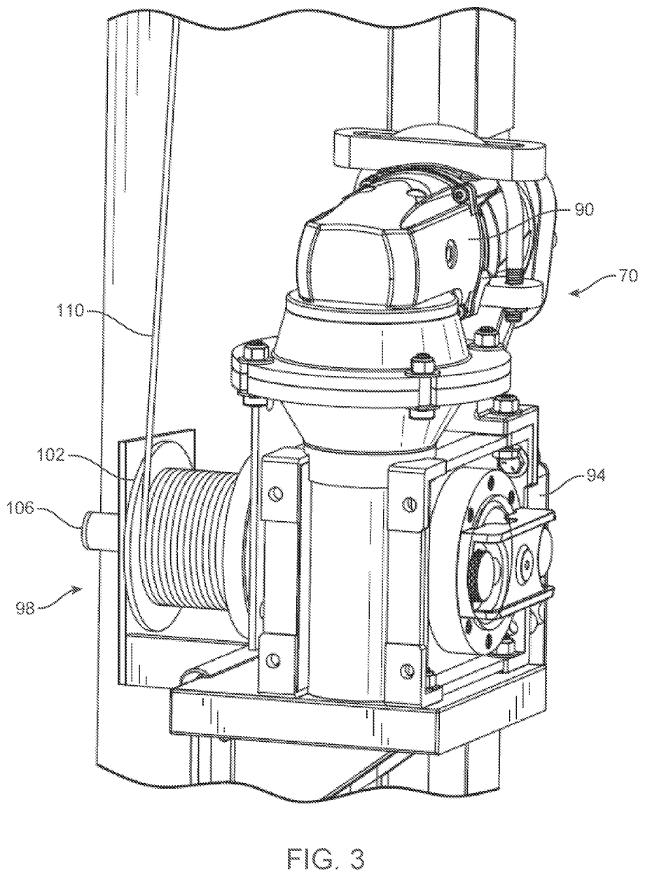

Now with reference to FIG. 3, the lifting assembly 70 is illustrated in detail. The lifting assembly 70 includes an electric motor 90, a gearbox assembly 94, and a winch 98 driven by the electric motor 90. The winch 98 includes a first spool 102 driven by a rotary shaft 106 and a cable 110 wound around the first spool 102 and coupled to the mast 30. The electric motor 90 is configured to alternately wind and unwind the cable 110 for raising and lowering the mast 30 relative to the base 14. In the illustrated embodiment, the cable 110 is affixed to the movable mast portions 58, 62 for alternately raising and lowering the movable mast portions 58, 62 relative to the stationary mast portion 48. The gearbox assembly 94 is positioned between and is operable to connect the electric motor 90 and the winch 98.

The electric motor 90 is a brushless direct-current (BLDC) motor having a power output of at least about 1800 W. In some embodiments, the electric motor 90 is a brushless direct-current (BLDC) motor having a power output ranging from 100 W to 4000 W. In one example, the electric motor 90 can be used with a battery pack 78 having a nominal voltage of 80 V. In another example, the electric motor 90 can be used with a battery pack 78 having a nominal voltage of 18 V.

The lifting device 10 includes a carrying capacity. The carrying capacity of the lifting device 10 is the carrying capacity of the carriage 34 including the first and second arms 38. The carrying capacity of the carriage 34 is determined by a weight of the load to be lifted and a load center. As shown in FIG. 1, the load center is measured from an interior surface 114 of the carriage 34 to a center of the load in a direction extending perpendicular to the interior surface 114. The load is placed as close as possible to the interior surface 114 to properly lift the load to the desired height and location.

Now with reference to FIG. 4, the lifting device 10 further includes the remote control unit 140. The remote control unit 140 is in wireless communication with a transceiver (i.e., combination transmitter/receiver) housed within the electronics housing 84 (FIG. 2). The remote control unit 140 includes a housing 144 defining a handle 148 (e.g., a pistol grip), a first user control 152, a stop button 156, and a trigger 158. The first user control 152 is operable to start the electric motor 90 of the lifting device 10. In some embodiments, the first user control 152 is able to immediately start the electric motor 90 at full or a predetermined initial speed, and then continuously operate the motor 90 at the full or predetermined initial speed thereafter. In other embodiments, the first user control 152 may be capable of starting the electric motor 90 at a predetermined initial speed and slowly accelerate (i.e., “soft start”) the motor 90 to a predetermined or user-selected final speed. The first user control 152 is further operable to control the vertical movement (e.g., in the first direction 74) of the mast 30 and carriage 34 relative to the base 14. The stop button 156 is operable to deactivate the electric motor 90 of the lifting device 10.

In one embodiment, the first user control 152 includes an up button 160 and a down button 164 that selectively activates the motor 90 of the lifting assembly 70 (FIG. 1) to move the mast 30 and carriage 34 upward or downward relative to the base 14 (e.g., in the first direction 74). The first user control 152 further selectively activates the motor 90 of the lifting assembly 70 to wind and unwind the cable 110 about the first spool 102. The stop button 156 is operable to stop, pause, or deactivate the lifting device 10. In some embodiments, when the auxiliary drive unit 120 is coupled to the motor 90, the remote control unit 140 includes the selector 136 to operate the auxiliary drive unit 120.

While the illustrated remote control unit 140 includes a pistol grip, it should be appreciated that the remote control unit 140 may have an alternative shape. At the same time, it should be appreciated that the user controls 136, 152, 156 may take different forms other than buttons (e.g., dial, touch screen display, switches, levers, etc.).

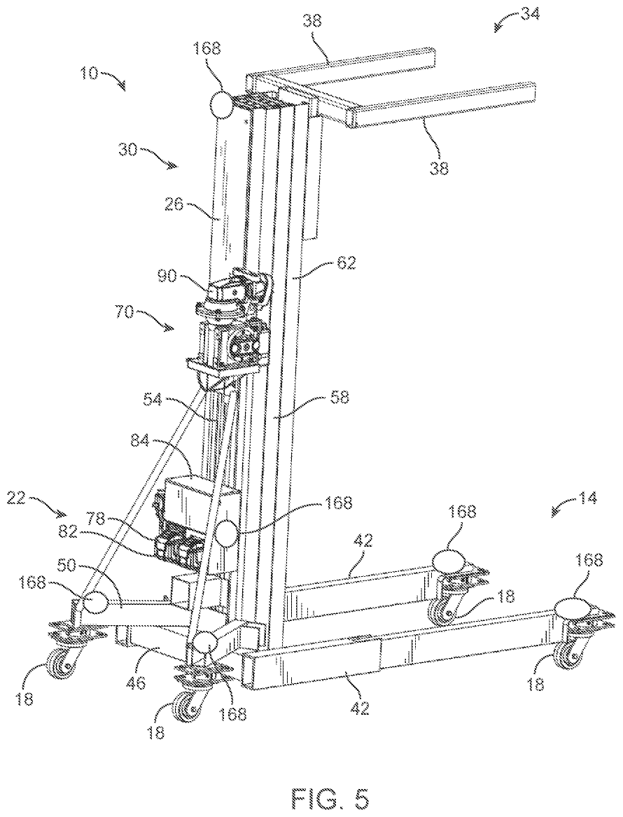

In some embodiments, with reference to FIGS. 1 and 4, the remote control unit 140 further includes an onboard user interface 166. In other embodiments, the user interface 166 can be onboard the lifting device 10. The user interface 166 is operable to communicate information about the lifting device 10 to the operator of the lifting device 10. The user interface 166 can include one or more light emitting diodes (i.e., LEDs). The user interface 166 can further include an LCD display. As described below, the user interface 166 can communicate information about a status of the lifting device 10 according to one or more metrics measured by one or more sensors 168 (FIG. 5). For example, the user interface 166 can communicate information about a weight and/or a center of gravity of a load to be lifted by the lifting device 10, a voltage of the one or more battery packs 78, and/or a number of lifts performed by the lifting device 10.

In operation, the operator sends instructions wirelessly to the lifting device 10 via the remote control unit 140 to operate the lifting assembly 70, and therefore, raise and lower the mast 30 and the carriage 34. The remote control unit 140 allows for remote operation of the lifting device 10 and reduces the manual labor required to operate the lifting device 10. The remote control unit 140 alleviates strain on the operator by removing the need to manually crank a hand wheel/lever to raise and lower the mast 30 and the carriage 34.

With reference to FIG. 5, the lifting device 10 further includes a means for detecting a status of the lifting device 10 according to one or more metrics. The lifting device 10 includes at least one sensor 168 configured to measure a status of the lifting device 10 according to one or more metrics such as a load carrying capacity, a cable tension, a current of the motor, a battery charge, a battery voltage, a battery low voltage state, a number of lifts performed by the lifting device 10, a predetermined or maximum number of lifts performed by the lifting device 10, etc. The sensors 168 are positioned on the base 14 to measure a load carrying capacity on the wheels 18. In some embodiments, the sensors 168 are located on the first spool 102 or cable 110 to measure a force or tension in the cable 110. In some embodiments, the one or more sensors 168 can be an impedance measurement circuit connected to the cable 110 configured to detect an increase in impedance due to cable fray, stretching, and/or damage.

In some embodiments, the sensors 168 are positioned in the one or more battery packs 78 to measure a charge or voltage of the one or more battery packs 78. In other embodiments, the sensors 168 are positioned within the electronics housing 84 to measure a status of the control electronics or a current of the motor 90. The sensors 168 can further track the power usage of the lifting device 10. Further, the sensors 168 can measure if a load's center of gravity is outside a support rectangle of the base 14. In still other embodiments, the sensors 168 can track a maximum lift height of the lifting device 10 and a lower lift height limit of the lifting device 10. The lifting device 10 prevents the operator from operating the lifting device 10 past the maximum lift height and lower than the lower lift height limit. In still other embodiments, the sensors 168 can detect a minimum battery voltage of the battery packs 78 needed for the lifting device 10 to complete a last lift (i.e., operating the lifting device 10 to complete one more lift to the maximum lift height and returning to the lower lift height limit before there's insufficient voltage in the battery packs 78 to perform another lift).

With reference back to FIG. 4, in some embodiments, the remote control unit 140 includes an indicator 172 to alert the operator of the status of the lifting device 10. In other embodiments, the indicator 172 is onboard the lifting device 10 to alert the operator of the status of the lifting device 10. The indicator 172 can alert the operator of the status of the lifting device 10 with the one or more dedicated light emitting diodes (e.g., LEDs) on the housing of the unit 140. Or, in other embodiments, the indicator 172 may be integrated with the user interface 166, permitting the indicator 172 to alert the operator of the status of the lifting device 10 through the

LCD display screen of the user interface 166. For example, the indicator 172 can include, but not limited to, an indication of when the load exceeds a safe operating limit of the lifting device 10, an indication of when the one or more battery packs 78 are depleted, an indication of when the cable 110 is damaged or unusable for a lifting operation, an indication of when a load's center of gravity is outside the support rectangle of the base 14, or identify an operating state or idling state of the lifting device 10. In still other embodiments, the indicator 172 can include, but not limited to, an alert of a last or final lift capable of the one or more battery packs 78, or an alert of when the lifting device 10 exceeds a predetermined or maximum number of lifts capable of the one or more battery packs 78. The alert indicating of when the lifting device 10 exceeds the predetermined number of lifts can indicate that the operator needs to replace the cable 110. In still other embodiments, the indicator 172 can include an alert of when the lifting device 10 is at a maximum lift height or a lower lift height limit.

FIG. 6 illustrates a sensor apparatus or configuration 200 configured to detect a load placed onto the carriage 34 and measure a weight of the load to be lifted by the lifting device 10. The sensor configuration 200 is arranged on the base 14. For example, the sensor configuration 200 is arranged on the rails 42, 50. The sensor configuration 200 includes sensors 204. In the illustrated embodiment, the sensor configuration 200 includes four sensors 204. The sensors 204 are placed at a distal end of each of the rails 42, 50. In other embodiments, more or fewer sensors 204 may be used. The sensors 204 may include load cells or strain gauges. The sensors 204 measure the weight of the load when placed onto the carriage 34. In some embodiments, the sensor configuration 200 further includes springs 208. In these embodiments, the sensors 204 measure a displacement of the springs 208 or a vertical distance the base 14 moves when a load is placed onto the carriage 34. The sensor configuration 200 measures a weight of the load similar to a force plate (or force scale) that measures an object or load placed onto the force plate. The sensor configuration 200 communicates the weight of the load and/or the center of mass location to the remote control unit 140 or user interface 166. The sensors 204 may output a voltage signal to the electronic control unit 86, which in turn interpolates the voltage signal to the weight of the load placed on the carriage 34. The voltage signal may be proportional to the weight of the load placed on the carriage 34.

In other embodiments, when the sensors 204 are configured as load cells, the sensors 204 are located between the rails 42, 50 and the wheels 18. The sensors 204 configured as load cells detect a vertical force exerted by the rails 42, 50 on the wheels 18. In some embodiments, the detected load on each of the sensors 204 can be averaged in an orthogonal coordinate system (e.g., x-axis, y-axis, z-axis) to calculate a location of a center of mass of the load placed on the carriage 34.

Still, in other embodiments, the base 14 includes rails arranged in a triangular shape with three wheels 18, where the wheels 18 are located at an apex of each adjacent pair of rails. In such an embodiment, the sensor configuration 200 can instead include three sensors 204 for measuring the total weight of the load placed on the carriage 34 and calculating the location of the center of mass of the load placed on the carriage 34.

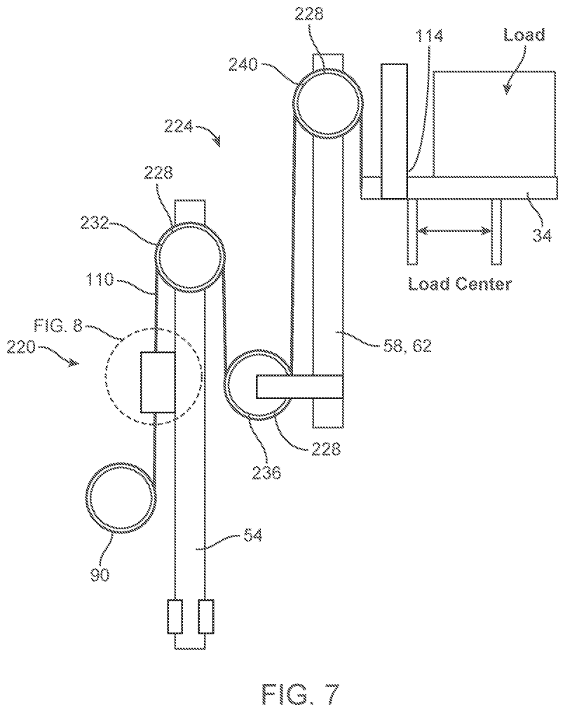

FIG. 7 illustrates a sensor apparatus or configuration 220 according to an embodiment of the invention for use with the lifting device 10. The sensor configuration 220 is configured to detect a load placed onto the carriage 34 and measure a weight of the load. As shown in FIG. 7, the lifting assembly 70 further includes a pulley system 224. The pulley system 224 includes at least one pulley 228. In other embodiments, more pulleys 228 may used in the pulley system 224. In the illustrated embodiment, the pulley system 224 includes three pulleys 228 such that the cable 110 is wound around each of the pulleys 228 and coupled to the carriage 34. For example, a first pulley 232 is positioned on the first mass portion 54, a second pulley 236 is positioned between the first mass portion 54 and the second mass portion 58, and a third pulley 240 is positioned on either the second or third movable mass portion 58, 62.

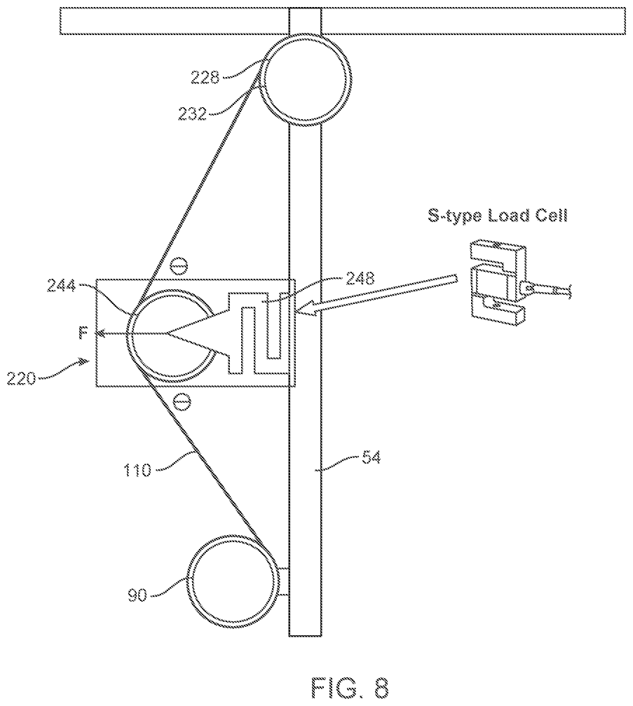

With reference to FIGS. 7 and 8, the sensor configuration 220 is positioned between the motor 90 and the first pulley 232. The sensor configuration 220 includes an idler pulley 244 and a load cell, such as an S-type load cell 248, attached thereto. The S-type load cell 248, for example, is available from Interface Force Measurement Solutions of Scottsdale, Arizona. The

S-type load cell 248 may include one or more strain gauges mounted to a deformable body having an “S” shape. The cable 110 is routed around the idler pulley 244 and the pulley system 224. A load is placed onto the carriage 34 to create a tension in the cable 110. The S-type load cell 248 deforms under the tension of the cable 110, which is partially wrapped around the idler pulley 244. The S-type load cell 248 may output a voltage signal to the electronic control unit 86, which in turn interpolates the voltage signal to the weight of the load placed on the carriage 34. The load's weight (or other metric) is then transmitted to the remote control unit 140 or user interface 166.

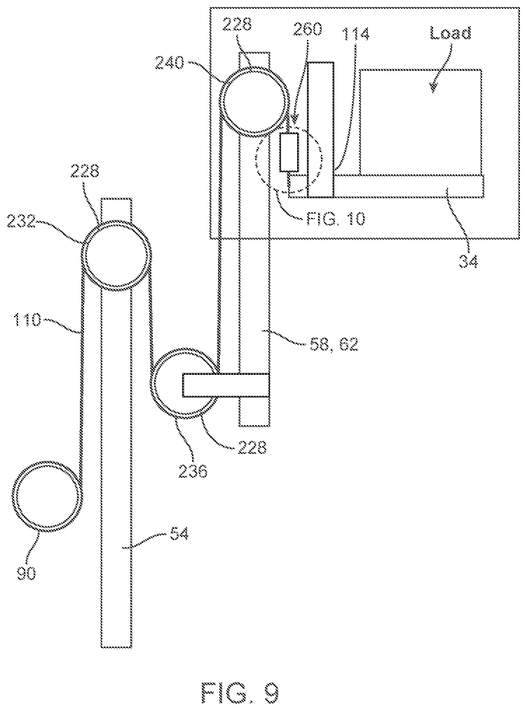

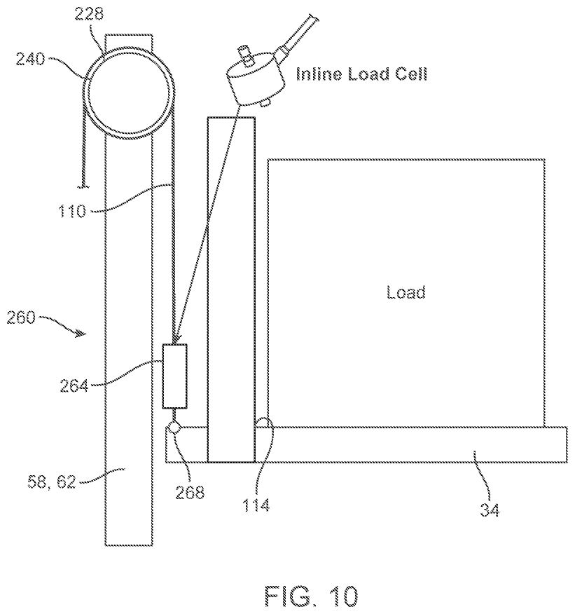

FIGS. 9 and 10 illustrate a sensor apparatus or configuration 260 according to an embodiment of the invention for use with the lifting device 10. The sensor configuration 260 is configured to detect a load placed onto the carriage 34 and measure a weight of the load. The sensor configuration 260 may be used with the pulley system 224 described above. The sensor configuration 260 may be used separately or in combination with the sensor configurations 200, 220 described above. The sensor configuration 260 includes an inline load cell 264. The inline load cell 264 may include a strain gauge. The inline load cell 264 is located on the cable 110 adjacent the carriage 34. The inline load cell 264 is positioned between a pulley 228 (e.g., third pulley 240) of the pulley system 224 and a cable attachment point 268 on the carriage 34. The inline load cell 264 measures a tension of the cable 110 when a load is placed onto the carriage 34. The inline load cell 264 may output a voltage signal to the electronic control unit 86, which in turn interpolates the voltage signal to the weight of the load placed on the carriage 34. The tension of the cable 110 is a metric used to determine the weight of the load to be lifted by the lifting device 10. The sensor configuration 260 communicates the weight of the load to the remote control unit 140 or user interface 166.

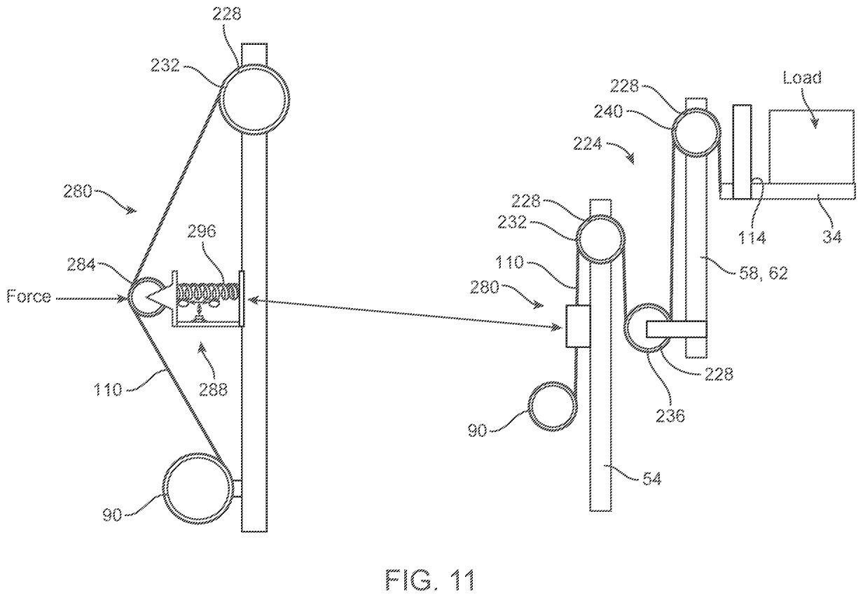

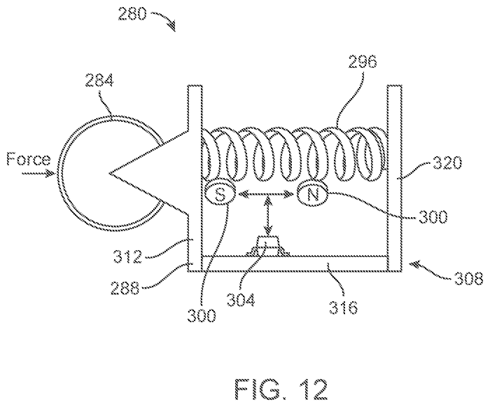

FIGS. 11 and 12 illustrate a sensor apparatus or configuration 280 according to an embodiment of the invention for use with the lifting device 10. The sensor configuration 280 is configured to detect a load placed onto the carriage 34 and measure a weight of the load by measuring the tension in the cable 110. The sensor configuration 280 may be used with the pulley system 224 described above. The sensor configuration 280 may be used separately or in combination with the sensor configurations 200, 260 described above.

As shown in FIG. 12, the sensor configuration 280 includes an idler pulley 284 and a housing 288 having a spring 296, one or more magnets 300, and a sensor 304. The idler pulley 284 is coupled to the housing 288 and configured to apply a force to the housing 288. In other embodiments, the idler pulley 284 is coupled to the spring 296 and applies a force to the spring 296. The cable 110 is routed around the idler pulley 284 and the pulley system 224.

The housing 288 includes a plurality of walls 308. For example, the housing 288 includes a first wall 312, a second wall 316, and a third wall 320 (FIG. 12). The first wall 312 may be a movable wall or include a movable portion coupled to the idler pulley 284. The second wall 316 is adjacent and connected to the first wall 312. The third wall 320 is adjacent and connected to the second wall 316.

The spring 296 is coupled to the plurality of walls 308 of the housing 288. For example, the spring 296 is coupled to the first wall 312 and the third wall 320. The spring 296 may be tuned or pre-loaded before being coupled to the walls 308 of the housing 288. The spring 296 is configured to compress in response to the applied force from the idler pulley 284. For example, the spring 296 is compressible from an initial state to a loaded state in response to a forced applied to the idler pulley 284 by a tension in the cable 110.

The one or more magnets 300 are coupled to the spring 296. The one or more magnets 300 may include one, two, three, or four magnets 300. In other embodiments, the one or more magnets 300 are coupled to one of the walls 308 of the housing 288. In one example, the one or more magnets 300 are coupled to the second wall 316 of housing 288. In the illustrated embodiment, the sensor configuration 280 includes two magnets 300 coupled to the spring 296.

The sensor 304 is coupled to one of the walls 308 of the housing 288. In the illustrated embodiment, the sensor 304 is coupled to the second wall 316. In other embodiments, the sensor 304 may be coupled to the spring 296. The sensor 304 is positioned between the one or more magnets 300. In the illustrated embodiment, the sensor 304 is positioned between two magnets 300. The sensor 304 may be a Hall-effect sensor for detecting a magnetic field produced from the one or more magnets 300. In other embodiments, the sensor 304 may be a load cell or a strain gauge. Still, in other embodiments, the sensor 304 may further be configured as a piezo-electric sensor, an encodes, or an induction sensor to detect the movement of the spring 296 or applied force from the idler pulley 284. In these embodiments, the sensor 304 outputs a voltage signal to the electronic control unit 86, which in turn interpolates the voltage signal to the weight of the load placed on the carriage 34.

In the illustrated embodiment, the sensor 304 is positioned between two magnets 300 that are coupled to the spring 296. The magnets 300 are spaced a fixed distance relative to each other. In operation, a load is placed onto the carriage 34 to create a tension in the cable 110. The idler pulley 284 applies a force to the housing 288 and in particular, the first wall 312 of the housing 288. The spring 296 is compressed under the applied force, where the position of the magnets 300 is changed relative to the sensor 304. The magnets 300 move relative to the sensor 304, but not relative to each other under the applied force. The sensor 304 detects a strength of the magnetic field produced from the magnets 300. The sensor 304 outputs a voltage signal dependent on the strength of the magnetic field. The sensor 304 outputs the voltage signal to the electronic control unit 86, which in turn interpolates the voltage signal to the weight of the load placed on the carriage 34.

In another embodiment, the sensor configuration 280 includes the sensor 304 positioned on the spring 296 and two magnets 300 that are fixed to the housing 288. For example, the two magnets 300 are fixed to the second wall 316 of the housing 288. In operation, a load is placed onto the carriage 34 to create a tension in the cable 110. The idler pulley 284 applies a force to the housing 288 and in particular, applies the force to the first wall 312 of the housing 288. The spring 296 is compressed under the applied force, where the position of the sensor 304 is changed relative to the magnets 300. The sensor 304 moves relative to the magnets 300 under the applied force. The sensor 304 detects a strength of the magnetic field produced from the magnets 300. The sensor 304 outputs a voltage signal dependent on the strength of the magnetic field. The sensor 304 outputs the voltage signal to the electronic control unit 86, which in turn interpolates the voltage signal to the weight of the load placed on the carriage 34.

Although the invention had been described in detail with reference to certain preferred embodiments, variations and modifications exist within the scope and spirit of one or more independent aspects of the invention as described.

Various features of the invention are set forth in the following claims.

What is claimed is:

1. A lifting device comprising:
a base;
a mast extending from the base;
a carriage coupled to the mast;
a lifting assembly configured to move the mast and the carriage in a first direction to a desired elevation relative to the base, the lifting assembly including an electric motor, a battery pack for providing electrical power to the electric motor, and a spool with a cable to alternately raise and lower the carriage in the first direction;
means for detecting a weight and/or a center of gravity of a load to be lifted by the lifting device; and
a user interface operable to communicate information about the weight and/or the center of gravity of the load to a user of the lifting device.

2. The lifting device of claim 1, wherein the detecting means includes at least one sensor to detect the weight of the load to be lifted by the lifting device.

3. The lifting device of claim 1, wherein the detecting means includes at least one sensor to detect the center of gravity of the load to be lifted by the lifting device.

4. The lifting device of claim 1, wherein the base includes a first base rail, a second base rail, a first frame rail, and a second frame rail.

5. The lifting device of claim 4, wherein the detecting means includes a first sensor located on the first base rail, a second sensor located on the second base rail, a third sensor located on the first frame rail, and a fourth sensor located on the second frame rail, wherein the first sensor, the second sensor, the third sensor, and the fourth sensor detect the weight of the load to be lifted by the lifting device.

6. The lifting device of claim 1, wherein the detecting means includes a S-type load cell to measure a tension in the cable when the load to be lifted by the lifting device is placed on the carriage, and wherein the S-type load cell is configured to output a voltage signal proportional to the weight of the load.

7. The lifting device of claim 1, wherein the detecting means includes an inline load cell located on the cable to measure a tension in the cable when the load to be lifted by the lifting device is placed on the carriage, and wherein the inline load cell is configured to output a voltage signal proportional to the weight of the load.

8. The lifting device of claim 1, wherein the detecting means includes a spring compressible from an initial state to a loaded state in response to the load carried by the carriage, and a sensor configured to detect movement of the spring from the initial state to the loaded state and output a voltage signal proportional to the weight of the load.

9. A lifting device comprising:
a base;
a mast coupled to the base;
a carriage coupled to the mast;
a lifting assembly configured to move the mast and carriage in a first direction to a desired elevation relative to the base, the lifting assembly including an electric motor, a battery pack for providing electrical power to the electric motor, and a spool with a cable to alternatively raise and lower the carriage in the first direction; and
means for detecting a tension in the cable in response to a load carried by the carriage, the detecting means configured to output a voltage signal proportional to a weight of the load.

10. The lifting device of claim 9, further comprising a user interface operable to communicate information about the weight of the load to a user of the lifting device.

11. The lifting device of claim 9, wherein the detecting means includes a S-type load cell to measure the tension in the cable when the load to be lifted is placed on the carriage.

12. The lifting device of claim 9, wherein the detecting means includes an inline load cell located on the cable to measure the tension in the cable when the load to be lifted is placed on the carriage.

13. The lifting device of claim 9, wherein the detecting means includes a sensor apparatus configured to detect the tension in the cable in response to the load carried by the carriage, the sensor apparatus including an idler pulley around which the cable is at least partially wrapped, and a load cell deformable in response to a force applied to the idler pulley by the tension of the cable, the load cell configured to output the voltage signal proportional to the weight of the load.

14. The lifting device of claim 13, wherein the load cell includes one or more strain gauges and a deformable body.

15. A lifting device comprising:
a base;
a mast coupled to the base;
a carriage coupled to the mast;
a lifting assembly configured to move the mast and carriage in a first direction to a desired elevation relative to the base, the lifting assembly including an electric motor, a battery pack for providing electrical power to the electric motor, and a spool with a cable to alternately raise and lower the carriage in the first direction; and
a sensor apparatus configured to detect a tension in the cable in response to a load carried by the carriage, the sensor apparatus including
an idler pulley around which the cable is at least partially wrapped,
a spring compressible from an initial state to a loaded state in response to a force applied to the idler pulley by the tension in the cable,
one or more magnets configured to emit a magnetic field, and
a sensor configured to detect the magnetic field emitted by the one or more magnets and output a voltage signal proportional to a weight of the load.

16. The lifting device of claim 15, wherein the one or more magnets are coupled to the spring and movable therewith in response to movement of the spring from the initial state to the loaded state.

17. The lifting device of claim 15, wherein the sensor is coupled to the spring and movable therewith in response to movement of the spring from the initial state to the loaded state.

18. The lifting device of claim 15, wherein the one or more magnets includes two magnets spaced a fixed distance relative to each other.

19. The lifting device of claim 15, wherein the sensor is a Hall-effect sensor.

20. The lifting device of claim 15, further comprising a user interface operable to communicate information about the weight of the load to a user of the lifting device.
